(19) United States
(12) Patent Application Publication
(10) Pub. No.: US 2002/0148869 A1
(43) Pub. Date: Oct. 17, 2002

(54) Saddlebag locking system

(76) Inventor: Jerome R. Oswald, Ferndale, MI (US)

Correspondence Address: Brian S. Pickell, Bliss McGlynn & Nolan, P.C., Suite 600, 2075 West Big Beaver Road, Troy, MI, 48084, US

(21) Appl. No.: 10/123,980

(22) Filed: Apr. 16, 2002

Related U.S. Application Data
(60) Provisional application No. 60/284,114, filed on Apr. 16, 2001.

(51) Int. Cl. B62J 7/00; B62J 9/00; B62J 11/00

(52) U.S. Cl. 224/413; 224/430

(57) ABSTRACT

A locking system for removably mounting and securing a saddlebag to a motorcycle includes a support rack adapted to support the saddlebag away from the motorcycle, a locking block connected to the motorcycle and adapted to support the support rack, and a removable lock adapted to be disposed through the saddlebag and the support rack and into the locking block to secure the saddlebag to the motorcycle.

### CROSS-REFERENCE TO RELATED APPLICATION

This application claims benefit of U.S. Provisional Patent Application No. 60/284,114 that was filed on Apr. 16, 2001 and is entitled “Saddlebag Locking System.”

### BACKGROUND OF THE INVENTION

1. Field of the Invention

The present invention relates, in general, to a saddlebag used in connection with a motorcycle and, in particular, to a mechanism for locking the saddlebag to the motorcycle.

2. Description of the Related Art

Many people travel on bicycles, mopeds, motorcycles, and other such cycles to and from home, work, school, a store, a gym, a vacation spot and other places and destinations near and far. Frequently, such a person carries various and often many objects on the cycle and his or her person. Saddlebags are particularly useful for carrying such objects while traveling over extended periods of time and distance.

A saddlebag, usually one of a pair, is generally carried on either side and over the back wheel of a motorcycle, for instance, and adapted for loading and carrying therein and unloading therefrom the objects. The saddlebag is continually removed from the motorcycle, such that a rider of the motorcycle can load and unload the saddlebag from various locations, and mounted back onto the motorcycle. Also, if a saddlebag is mounted to a motorcycle, the rider thereof may decide to ride the motorcycle without the saddlebag and remove it from the motorcycle.

The most common system for mounting a saddlebag to a motorcycle is the use of a fastener in the form of a bolt and a nut. This system, unfortunately, is not readily attachable to and detachable from the motorcycle and requires a semi-permanent attachment of a great amount of hardware to the motorcycle.

To overcome these problems, it would be highly advantageous to employ a saddlebag-locking system that does not require distracting hardware. Also, such a system must not only removably mount the saddlebag to the motorcycle, but also mount the saddlebag such that it does not impede safe operation of the motorcycle and comfort of the driver and passenger thereof. In addition, it is of utmost importance that the system securely fastens the saddlebag to the motorcycle such that the saddlebag remains in a stable position when the motorcycle encounters the high-wind forces typically experienced at highway speeds.

Since there are many models of cycles, many types of mountings of a saddlebag to a motorcycle may be desired. Accordingly, the system not only must accomplish the objectives stated above, but it would be highly desirable if the system could also be used on a great number of different motorcycle constructions without requiring substantial modifications of a particular motorcycle to effectuate the system.

This invention is directed to solving the above-identified problems while accomplishing these objectives. More specifically, this invention relates to a universal-mounting system for a motorcycle saddlebag and the like. Such a system obviates the need for a wide variety of mountings by providing a universal system that can be adapted for use with a great number of different brands and types of motorcycles. The system also permits wide latitude in the positioning of the saddlebag on the motorcycle for rider comfort and proper clearances. These results are achieved in a simple and economical system that can be readily installed in the field with a minimum amount of difficulty.

### BRIEF SUMMARY OF THE INVENTION

This invention overcomes the problems in the related art in a locking system for removably mounting and securing a saddlebag to a motorcycle that includes a support rack adapted to support the saddlebag away from the motorcycle, a locking block connected to the motorcycle and adapted to support the support rack, and a removable lock adapted to be disposed through the saddlebag and the support rack and into the locking block to secure the saddlebag to the motorcycle.

An advantage of the saddlebag-locking system of this invention is that it permits a saddlebag to be readily attached to and detached from a motorcycle.

Another advantage of the saddlebag-locking system of this invention is that it permits a saddlebag to be mounted to a motorcycle such that the saddlebag does not impede safe operation of the motorcycle and comfort of the driver and passenger thereof.

Another advantage of the saddlebag-locking system of this invention is that it permits a saddlebag to be securely fastened to a motorcycle and remain in a stable position when the motorcycle encounters the high-wind forces typically experienced at highway speeds.

Another advantage of the saddlebag-locking system of this invention is that it can be used on a great number of different motorcycle constructions without requiring substantial modifications of a particular motorcycle to effectuate the system.

Another advantage of the saddlebag-locking system of this invention is that it does not require a semi-permanent attachment of a great amount of distracting hardware to a motorcycle.

Another advantage of the saddlebag-locking system of this invention is that it obviates the need for a wide variety of mountings by providing a universal system that can be adapted for use with a great number of different brands and types of motorcycles.

Another advantage of the saddlebag-locking system of this invention is that it permits wide latitude in the positioning of a saddlebag on a motorcycle for rider comfort and proper clearances.

Another advantage of the saddlebag-locking system of this invention is that it is simple and economical and can be readily installed in the field with a minimum amount of difficulty.

Other features, objects, and advantages of this invention will be readily appreciated as the same becomes better understood while reading the subsequent description when taken in conjunction with the accompanying figures.

### BRIEF DESCRIPTION OF THE SEVERAL VIEWS OF THE DRAWING

FIG. 1 is an environmental elevational front view of an embodiment of the saddlebag-locking system of this invention showing the system mounting a saddlebag to a part of a motorcycle;

FIG. 2 is an elevational cross-sectional side view of the support rack of the embodiment of the saddlebag-locking system of this invention shown in FIG. 1;

FIG. 3 is an elevational top view of section 3-3 of FIG. 2;

FIG. 4 is an environmental elevational front view of another embodiment of the saddlebag-locking system of this invention showing the system mounting a saddlebag to a part of a motorcycle;

FIG. 5 is an environmental elevational front view of another embodiment of the saddlebag-locking system of this invention showing the system mounting a saddlebag to a part of a motorcycle;

FIG. 6 is an environmental elevational front view of another embodiment of the saddlebag-locking system of this invention showing the system mounting a saddlebag to a part of a motorcycle;

FIG. 7 is an elevational cross-sectional t op view of the embodiment of the saddlebag-locking system of this invention shown in FIG. 6;

FIG. 8 is an elevational cross-sectional side view of the embodiment of the saddlebag-locking system of this invention shown in FIG. 6;

FIG. 9 is an environmental elevational front view of another embodiment of the saddlebag-locking system of this invention showing the system mounting a saddlebag to a part of a motorcycle;

FIG. 10 is an elevational cross-sectional side view of the support rack of the embodiment of the saddlebag-locking system of this invention shown in FIG. 9;

FIG. 11 is an elevational cross-sectional top view of the embodiment of the saddlebag-locking system of this invention shown in FIG. 9;

FIG. 12 is an elevational cross-sectional front view of a locking-fender strut of the embodiment of the saddlebag-locking system of this invention shown in FIG. 9;

FIG. 13 is an elevational cross-sectional side view of the locking-fender strut shown in FIG. 12;

FIG. 14 is an environmental elevational front view of another embodiment of the saddlebag-locking system of this invention showing the system mounting a saddlebag to a part of a motorcycle;

FIG. 15 is an elevational cross-sectional side view of the support rack of the embodiment of the saddlebag-locking system of this invention shown in FIG. 14;

FIG. 16 is an elevational cross-sectional top view of the embodiment of the saddlebag-locking system of this invention shown in FIG. 14; and

FIG. 17 is an elevational cross-sectional side view of another embodiment of the saddlebag-locking system of this invention.

### DETAILED DESCRIPTION OF THE INVENTION

Referring now to the figures, throughout which like numerals are used to represent like structure, a saddlebag locking system of this invention is generally indicated at 10. In the figures and the description of the saddlebag locking system 10 that follows, the saddlebag locking system 10 is shown and described in connection with mounting a saddlebag 12 to a motorcycle (not shown). However, those having ordinary skill in the art will appreciate that the saddlebag locking system 10 is not limited for mounting saddlebags to motorcycles. The saddlebag locking system 10 can be used to mount any suitable package or article carrier or receiver that is specially adapted to be supported upon or attached to any suitable vehicle. Also, throughout the figures, the saddlebag 12 is shown having a substantially rectangular shape. However, those having ordinary skill in the art will appreciate that the saddlebag can be of any suitable shape and size and made of any suitable material. Further, throughout the figures, only one of a pair of saddlebags is shown mounted to a side of the motorcycle.

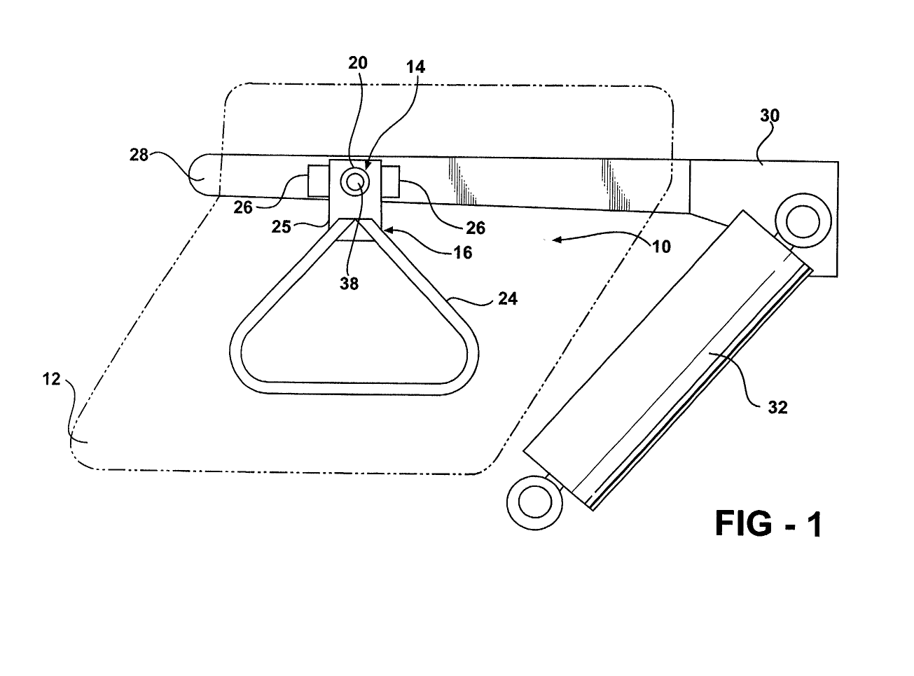

As best shown in FIGS. 1, 4, 5, 6, 9, and 14, the saddlebag locking system 10 is adapted to removably mount and secure the saddlebag 12 to the motorcycle. Generally, the saddlebag locking system 10 includes a removable lock, generally indicated at 14, a support rack, generally indicated at 16, and a locking block 18. The support rack 16 is adapted to support the saddlebag 12 away from the motorcycle. The locking block 18 is connected to the motorcycle and adapted to support the support rackl6. The lock 14 is adapted to be disposed through the saddlebag 12 and the support rack 16 and into the locking block 18 to secure the saddlebag to the motorcycle.

A preferred embodiment of the saddlebag locking system 10 is shown in FIGS. 1-3. As best shown in FIGS. 1 and 3, the lock 14 is a cylinder/barrel lock 14 adapted to be actuated by a combination key or a coded key (not shown), which will be described in greater detail below. More specifically, the lock 14 includes a substantially disk-shaped head portion 20 and a stem portion 22 extending substantially perpendicularly from the central area of a face of the head portion 20.

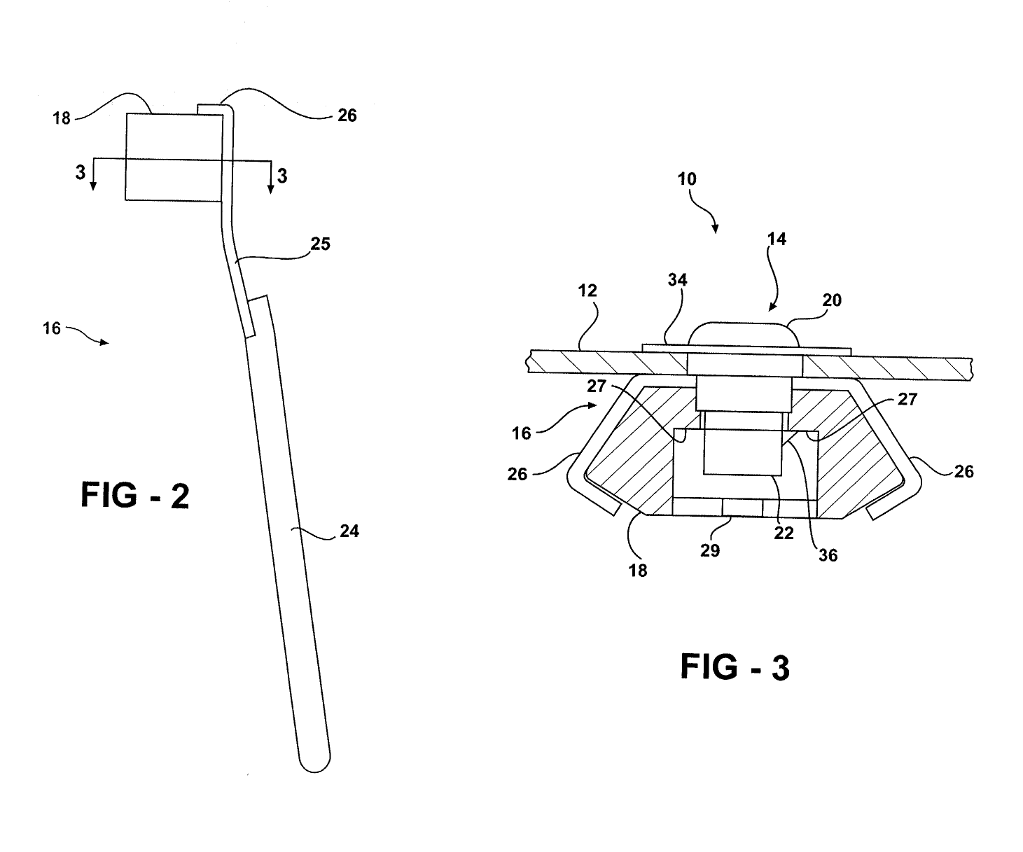

As best shown in FIG. 1, the support rack 16 includes a substantially equilaterally triangularly shaped bar portion 24 two vertices of which are substantially arcuate and the other vertex of which is substantially linear. The volume defined within the legs of the substantial triangle is substantially hollow. As best shown in FIGS. 1 through 3, the support rack 16 further includes a connecting portion 25 having a substantially rectangularly shaped cross-section and a mounting portion 26 having a substantially trapezoidally shaped cross-section and integrally connected to the connecting portion 25. As best shown in FIGS. 1 and 2, the linear vertex of the bar portion 24 is connected to a substantially central area of a longitudinal end of the connecting portion 25. As best shown in FIG. 3, the interior of the mounting portion 26 defines a volume of space.

As best shown in FIG. 3, the locking block 18 is substantially disposed within the volume of space such that the mounting portion 26 substantially encloses the locking block 18 in a substantially contacting manner. A portion of the interior of the locking block 18 also defines a volume of space such that at least one step 27 is defined. Two steps 27 are shown in FIG. 3.

As best shown in FIG. 3, a conventional fastener 29, such as a screw, is spaced from the longitudinal end of the stem portion 22 opposite the head portion 20 and adapted to secure the locking block 18 to the motorcycle. Those having ordinary skill in the art will appreciate that the lock 14, the support rack 16, and the locking block 18 and any parts thereof can be of any suitable size and shape.

As best shown in FIG. 1, a longitudinal end of the saddlebag 12 is mounted to and disposed substantially coextensively with a substantially straight fender portion 28 of the motorcycle. In this position, the length of the saddlebag 12 is disposed substantially perpendicularly to the fender portion 28, and the width of the saddlebag 12 is disposed substantially parallel with the fender portion 28. A partially rectangularly shaped strut portion 30 of the motorcycle is connected to and substantially co-extends from a longitudinal end of the fender portion 28 and is substantially parallel with the fender portion 28 such that the strut portion 30 is adjacent the saddlebag 12. A substantially straight shock 32 is connected to and extends from the strut portion 30 substantially parallel with and proximate the saddlebag 12. The saddlebag locking system 10 is disposed on a substantially central portion of the fender portion 28.

Those having ordinary skill in the art will appreciate that the saddlebag 12 can be mounted at any suitable point or area on the fender portion 28 and with any suitable geometric relationship to the fender portion 28, strut portion, 30, and shock 32. Those having ordinary skill in the art will appreciate also that the fender portion 28, strut portion, 30, and shock 32 can have any suitable geometric relationship to each other.

As best shown in FIGS. 1 and 3, the stem portion 22 is inserted through a washer 34, then through a hole in and defined by the saddlebag 12, then through a substantially central area of the mounting portion 26, and then into the locking block 18, which is secured to the fender portion 28. In the mounted state of the saddlebag 12, the face of the head portion 20 proximate the stem portion 22 is in contacting relationship with the side of the washer 34 opposite the saddlebag 12. Also, the side of the washer 34 opposite the head portion 20 is in contacting relationship with the saddlebag 12, the side of which opposite the washer 34 is in contacting relationship with the mounting portion 26, the side of which opposite the saddlebag 12 is in contacting relationship with the locking block 18, and the side of which opposite the saddlebag 12 is in contacting relationship with the fender portion 28.

Importantly, at least one detent mechanism 36 is adapted to substantially prevent and permit axial movement of the lock 14. FIG. 3 shows a flange 36 adapted to protrude substantially perpendicularly outwardly from a portion of the stem portion 22 distal the head portion 20 to abuttingly contact the step 27 to substantially prevent axial movement of the lock 14. The flange 36 is adapted to protrude also inwardly into the portion of the stem portion 22 to substantially eliminate abutting contact with the step 27 to substantially permit axial movement of the lock 14. One detent mechanism 36 is shown in FIG. 3. However, those having ordinary skill in the art will appreciate that the structure of the detent mechanism and number of detent mechanisms 36, preferably matching the number of steps 27, can vary. The combination key and/or the coded key is adapted to actuate the detent mechanism 36.

The bar portion 24 is adapted to maintain the saddlebag 12 disposed away from the rear swing arm (not shown), sprocket (not shown), chain (not shown), belt or drive shaft (not shown), and/or rear-wheel-break caliper (not shown) of the motorcycle. The locking block 18 is adapted to receive and secure the stem portion 22 and also support the mounting portion 26, thus, preventing the support rack 16 from falling off the motorcycle.

As best shown in FIG. 1, the locking block 18 includes at least one hole 38—preferably, a plurality of holes 38—adapted to accept a combination key or coded key. The key is adapted upon actuation thereof to release the detent mechanism 36 from within the stem portion 22 to lock the saddlebag 12 to the motorcycle or return the detent mechanism 36 back into the stem portion 22 to remove the saddlebag 12 from the motorcycle. Those having ordinary skill in the art will appreciate that the number of holes 38 can vary. Moreover, the locking block 18 can include a plurality of holes (not shown) adapted to accept a bungi cord (not shown) for securing additional items to the motorcycle.

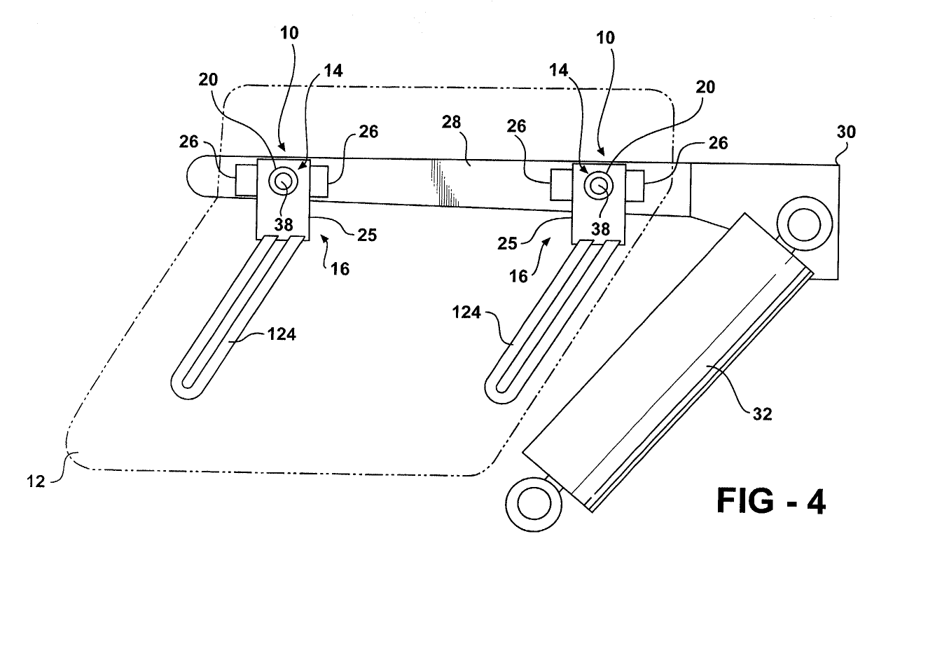

In another preferred embodiment of the saddlebag locking system 10 shown in FIG. 4, the support rack 16 has a substantially U-shaped bar portion 124, which is a variant of bar portion 24, the open end of which is connected to the connecting portion 25. In this embodiment, the saddlebag locking system 10 is disposed substantially on each longitudinal end of the fender portion 28.

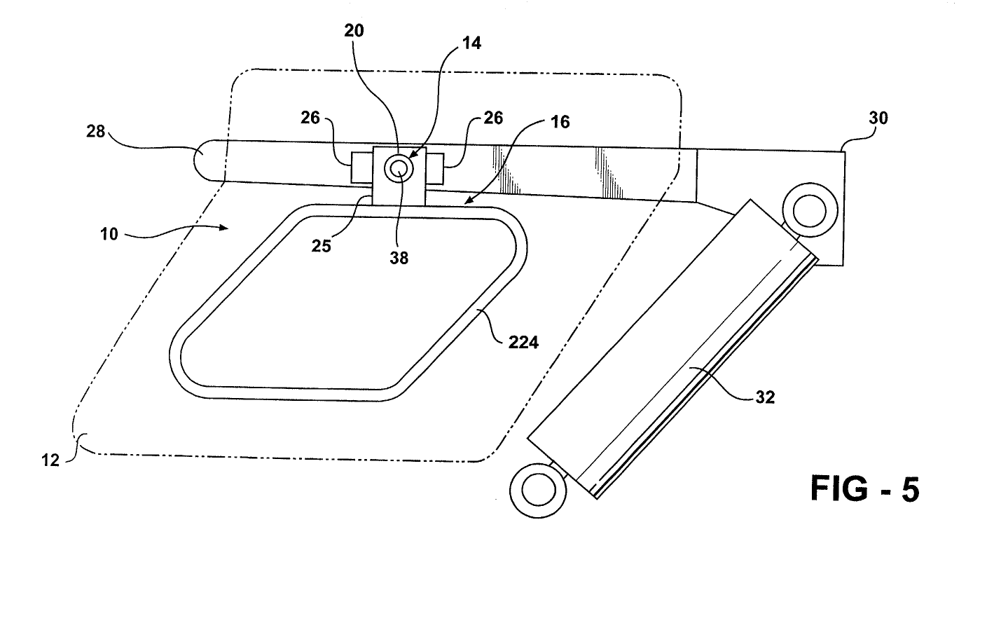

In another preferred embodiment of the saddlebag locking system 10 shown in FIG. 5, the support rack 16 has a substantially rhombus-shaped bar portion 224. A substantially central portion of a side of the bar portion 224, which is a variant of bar portions 24 and 124, is disposed upon the connecting portion 25. In this embodiment, the saddlebag locking system 10 is disposed on a substantially central portion of the fender portion 28.

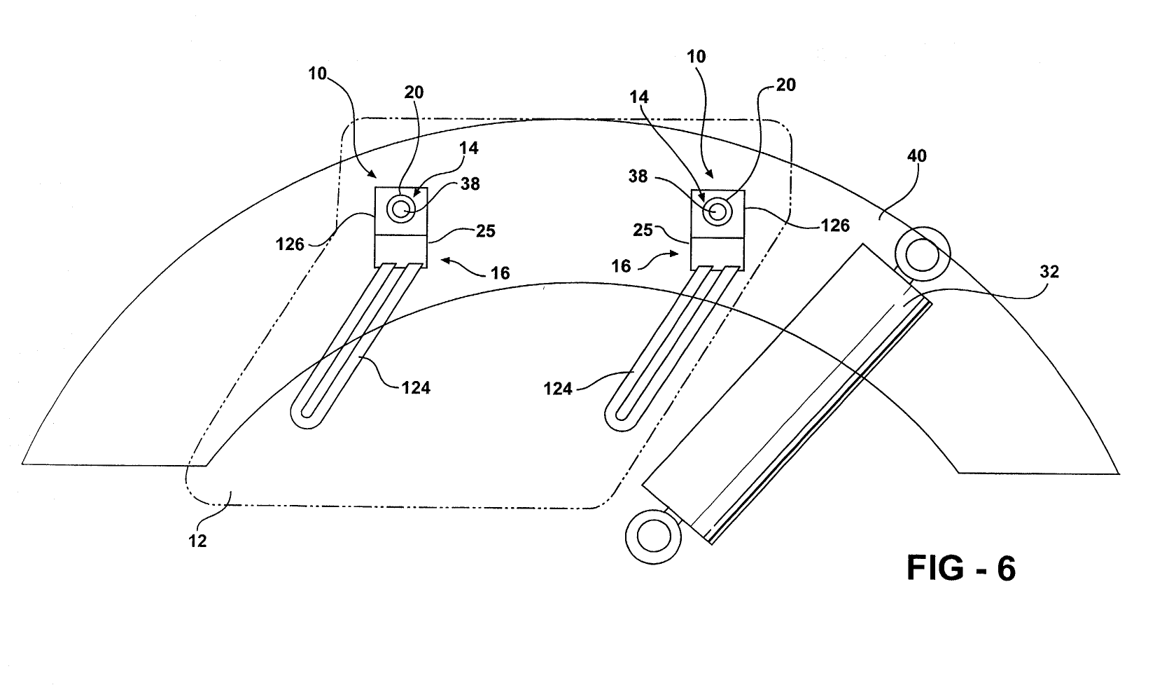

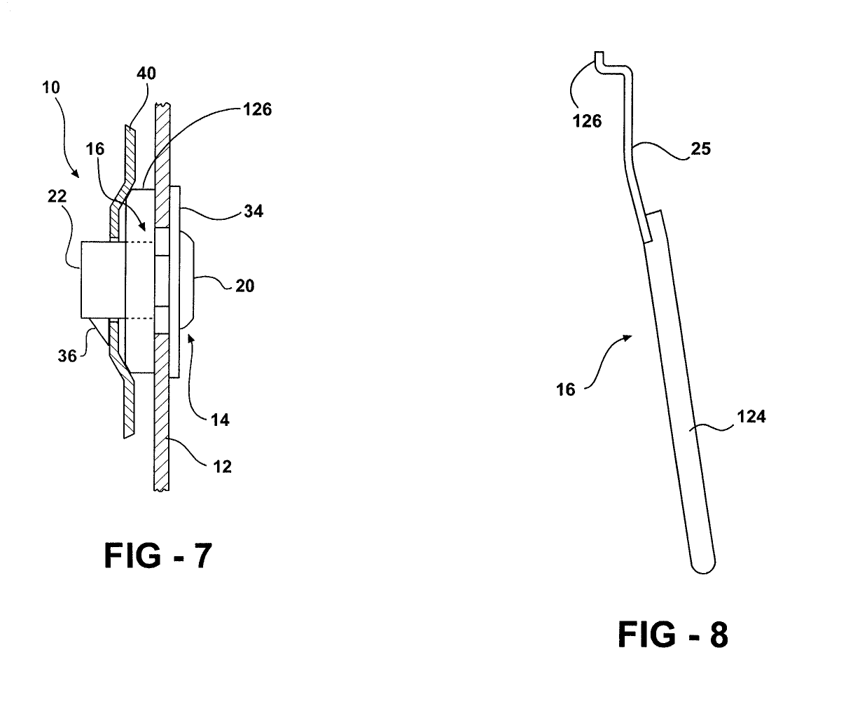

Referring now to FIGS. 6-8, in another preferred embodiment of the saddlebag locking system 10, the locking block 18 is eliminated. A substantially arcuately shaped fender 40, best shown in FIG. 7, of the motorcycle having a locking catch (not shown) is adapted to receive and secure the lock 14. In this embodiment, the bar portion 124, best shown in FIG. 6, is used, and the saddlebag locking system 10 is disposed substantially equidistantly to each side of a central portion of the fender 40. In this embodiment, as best shown in FIG. 7, the mounting portion 126, which is a variant of mounting portion 26, has a substantially rectangularly shaped cross-section. The holes 38 can be disposed within the motorcycle to accept the combination key or the coded key.

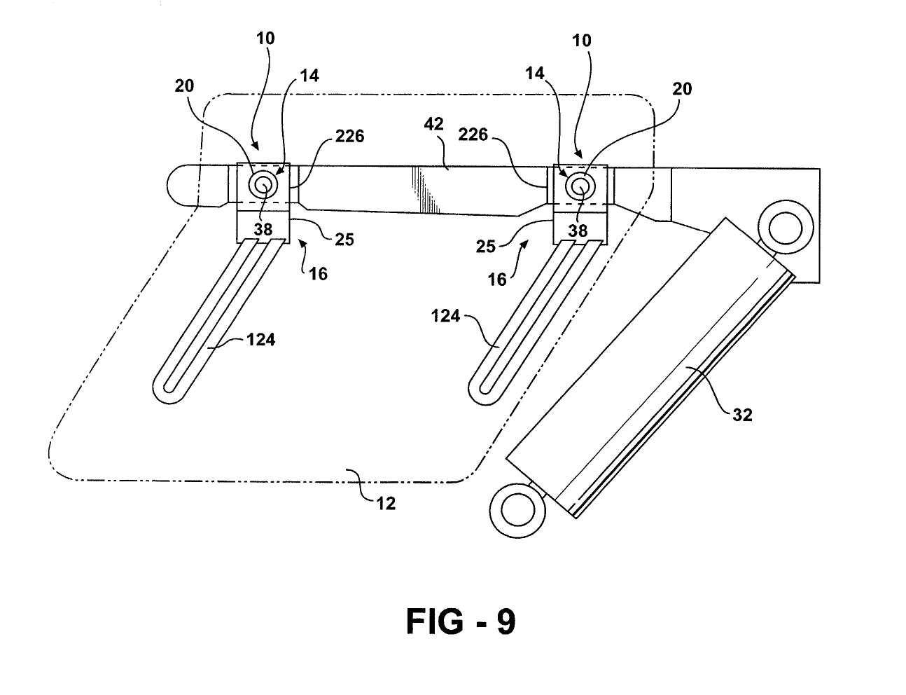

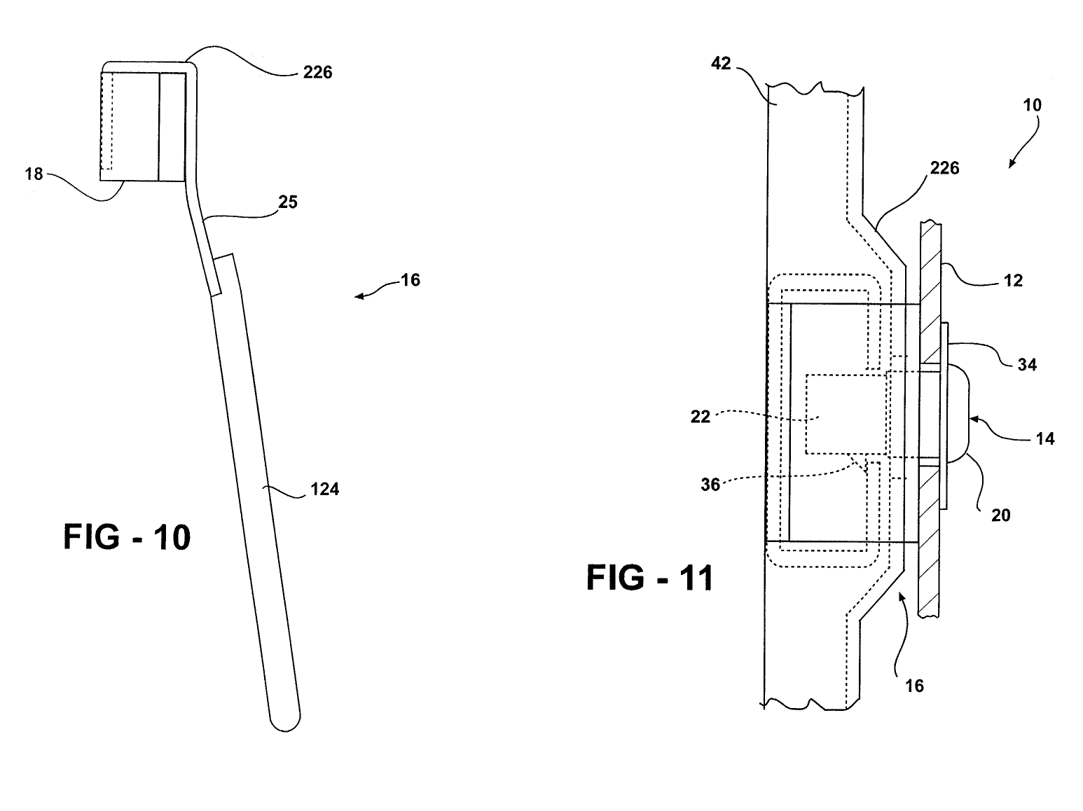

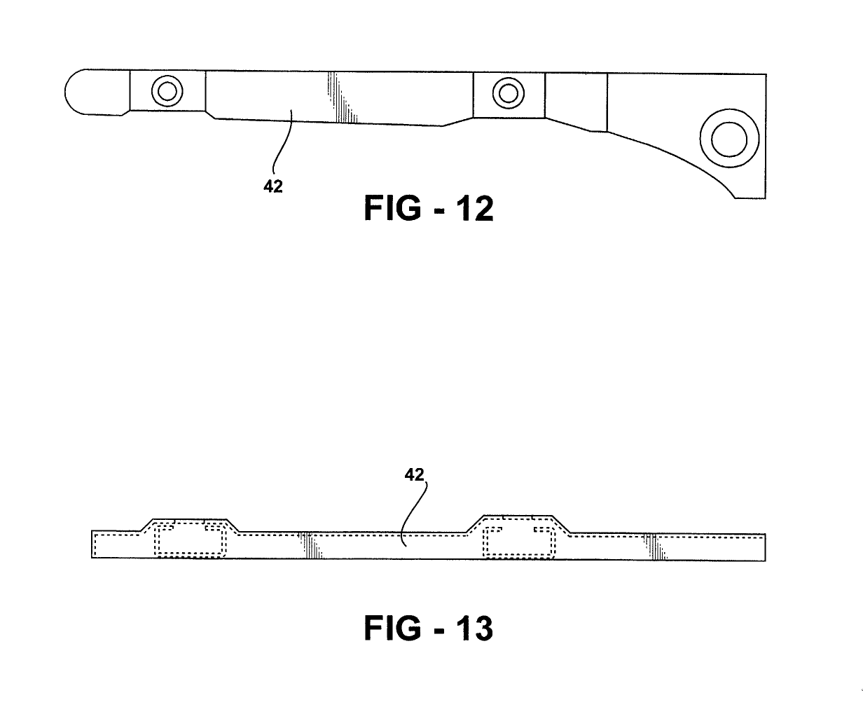

Referring now to FIGS. 9-13, in another preferred embodiment of the saddlebag locking system 10, the locking block 18 is eliminated. A locking-fender strut 42, best shown in FIGS. 9, 12, and 13 of the motorcycle is adapted to receive and secure the lock 14. In this embodiment, the bar portion 124, best shown in FIG. 9, is used, and the saddlebag locking system 10 is disposed substantially equidistantly to each side of a central portion of the locking-fender strut 42. The mounting portion 226, which is a variant of mounting portions 26 and 126, is best shown in FIGS. 10 and 11. Again, the holes 38 can be disposed within the motorcycle to accept the combination key or the coded key.

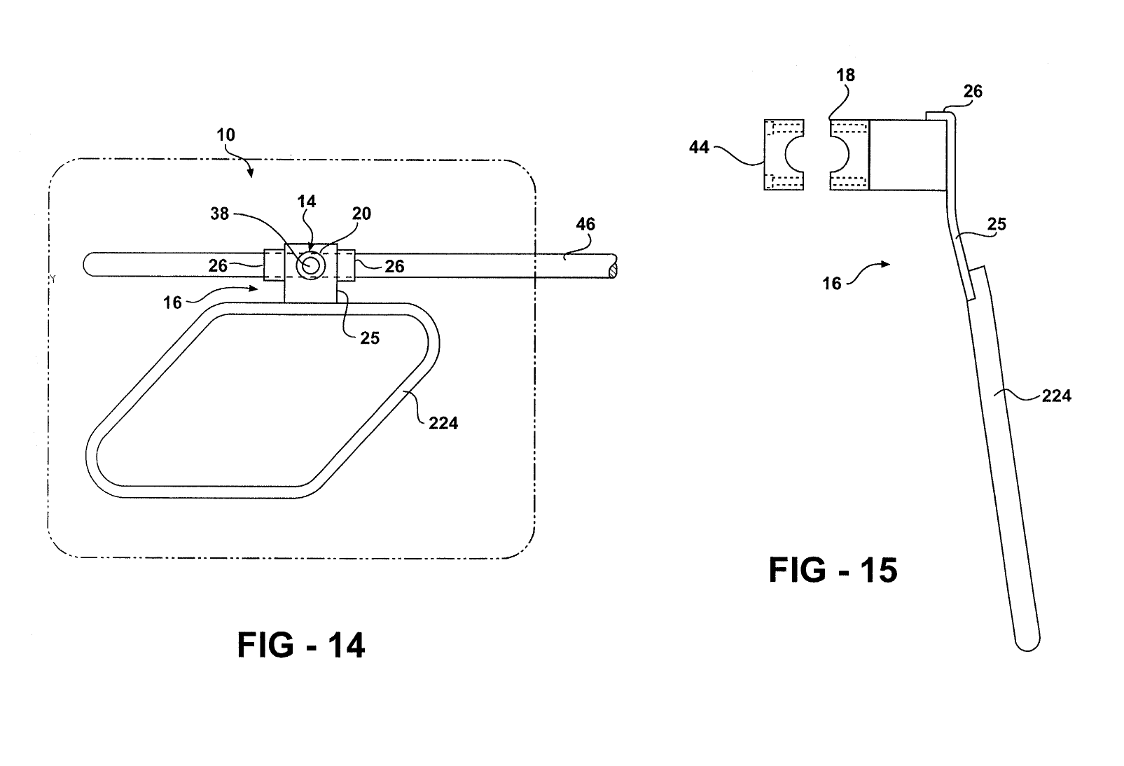

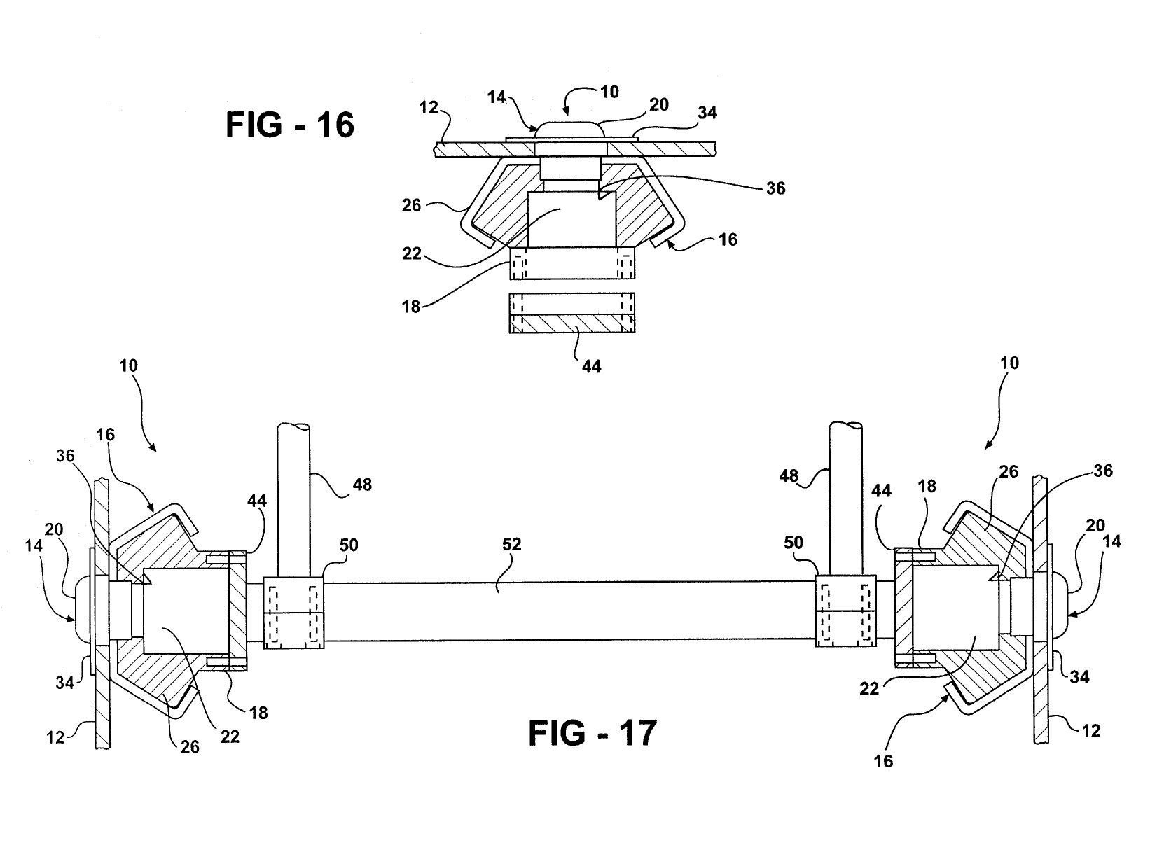

Referring now to FIGS. 14-16, in another preferred embodiment of the saddlebag locking system 10, a clamp 44, best shown in FIGS. 15 and 16, is connected to a side of the locking block 18 opposite the saddlebag 12. A frame mount or a frame 46, best shown in FIG. 14, of the motorcycle is adapted to receive and secure the clamp 44. In this embodiment, the bar portion 224, best shown in FIG. 14, is used, and the saddlebag locking system 10 is disposed on a substantially central portion of the frame 46. The mounting portion 26 is best shown in FIGS. 15 and 16. The holes 38 can be disposed within the locking block 18 to accept the combination key or the coded key.

Another preferred embodiment of the saddlebag locking system 10 shown in FIG. 17 is used in connection with a short-framed motorcycle. Extension bars 48 of a pair thereof are adapted to be disposed along opposite sides of the motorcycle. Each of the extension bars 48 is adapted to be mounted to the frame 46. Specifically, each of the extension bars 48 can include a plurality of holes therein for mounting the extension bar 48 by conventional means to the frame 46. Each of the extension bars 48 also includes a clamp block 50 disposed at a longitudinal end of the extension bar 48 such that the clamp blocks 50 are in opposed relation to each other. A cross-over bar 52 is adapted to extend between and connect the clamp blocks 50. The side of each of the clamps 44 opposite the saddlebag 12 is adapted to be connected to a clamp block 52 to, thereby, secure the saddlebag locking system and, hence, the saddlebag 10 to the motorcycle.

In another preferred embodiment (not shown) of the saddlebag locking system 10, the support rack 16 can be eliminated if the area of the saddlebag 12 disposed adjacent the motorcycle is made with a hard backing or the saddlebag 12 is made of fiberglass, plastic, or other such material. In this embodiment, the locking block 18 is connected to the motorcycle. The stem portion 22 is adapted to be disposed through the saddlebag 12 and into the locking block 18 to secure the saddlebag 12 to the motorcycle. At least one detent mechanism 36 is adapted to substantially prevent axial movement of the lock 14 to secure the saddlebag 12 and permit axial movement of the lock 14 to release the saddlebag 12. At least one of a combination key and a coded key is adapted to actuate the detent mechanism 36. The locking block includes at least one hole-preferably, a plurality of holes-adapted to accept the combination key or the coded key.

In accordance with the above description, the saddlebag locking system 10 can removably mount a saddlebag 12 to a motorcycle in such a manner that the saddlebag 12 does not impede safe operation of the motorcycle or comfort of the passenger(s) thereof. Also, the saddlebag 12 can be securely fastened to the motorcycle and remain in a stable position when the motorcycle encounters the high-wind forces typically experienced at highway speed. And, the saddlebag locking system 10 can be used on a great number of different motorcycle constructions without requiring substantial modifications of the motorcycle to effectuate the saddlebag locking system 10.

An advantage of the saddlebag locking system 10 over other systems in the related art is that the saddlebag 12 is readily attachable to and detachable from the motorcycle. Another advantage of the saddlebag locking system 10 is that it does not require a semi-permanent attachment of a great amount of distracting hardware to the motorcycle. Furthermore, the saddlebag locking system 10 obviates the need for a wide variety of mountings by providing a universal system that can be adapted for use with a great number of different brands and types of motorcycles. In addition, the saddlebag locking system 10 permits wide latitude in the positioning of a saddlebag for best rider comfort and proper clearances. Moreover, the saddlebag locking system 10 is simple and economical and can be readily installed in the field with a minimum amount of difficulty.

This invention has been described in an illustrative manner. It is to be understood that the terminology that has been used is intended to be in the nature of words of description rather than of limitation. Many modifications and variations of the present invention are possible in light of the above teachings. Therefore, the present invention may be practiced other than as specifically described.

I claim:

1. A locking system for removably mounting and securing a saddlebag to a motorcycle, said system comprising:
a support rack adapted to support the saddlebag away from the motorcycle;
a locking block connected to the motorcycle and adapted to support said support rack; and
a removable lock adapted to be disposed through the saddlebag and said support rack and into said locking block to secure the saddlebag to the motorcycle.

2. The locking system as recited in claim 1, wherein said support rack includes a bar portion adapted to support the saddlebag away from the motorcycle and a mounting portion adapted to mount the saddlebag and be supported by said locking block.

3. The locking system as recited in claim 1, wherein an interior portion of said support rack defines a volume of space, said locking block being substantially disposed within the volume of space such that said support rack substantially encloses said locking block.

4. The locking system as recited in claim 1, further including at least one detent mechanism adapted to substantially prevent axial movement of said lock to secure the saddlebag and permit axial movement of said lock to release the saddlebag.

5. The locking system as recited in claim 4, wherein an interior portion of the locking block defines a volume of space such that at least one step is defined and said at least one detent mechanism is adapted to protrude outwardly from a portion of said lock to abuttingly contact said at least one step to substantially prevent axial movement of said lock and protrude inwardly into the portion of said lock to substantially eliminate abutting contact with said at least one step to substantially permit axial movement of said lock.

6. The locking system as recited in claim 4, further including at least one of a combination key and a coded key adapted to actuate said detent mechanism.

7. The locking system as recited in claim 6, further including at least one hole adapted to accept said at least one of a combination key and a coded key.

8. The locking system as recited in claim 7, wherein said locking block includes said at least one hole.

9. The locking system as recited in claim 1, wherein a fastener is adapted to secure the locking block to the motorcycle.

10. The locking system as recited in claim 9, wherein the fastener is spaced from the lock.

11. The locking system as recited in claim 1, wherein said locking block includes a clamp adapted to be connected to the motorcycle.

12. The locking system as recited in claim 11, further including an extension bar adapted to be disposed along and mounted to a side of the motorcycle, said extension bar including a clamp block disposed thereon and adapted to be connected to said clamp, said extension bar adapted also to be connected to another extension bar having a clamp block by a cross-over bar adapted to extend between and connect the clamp blocks.

13. A locking system for removably mounting and securing a saddlebag to a motorcycle, said system comprising:
a support rack adapted to support the saddlebag away from the motorcycle; and
a removable lock adapted to be disposed through the saddlebag and said support rack and into the motorcycle to secure the saddlebag to the motorcycle.

14. The locking system as recited in claim 13, further including at least one detent mechanism adapted to substantially prevent axial movement of said lock to secure the saddlebag and permit axial movement of said lock to release the saddlebag.

15. The locking system as recited in claim 14, wherein said at least one detent mechanism is adapted to protrude outwardly from a portion of said lock to abuttingly contact the motorcycle to substantially prevent axial movement of said lock and protrude inwardly into the portion of said lock to substantially eliminate abutting contact with the motorcycle to substantially permit axial movement of said lock

16. The locking system as recited in claim 15, wherein the motorcycle includes at least one locking catch adapted to contact said at least one detent mechanism.

17. The locking system as recited in claim 14, further including at least one of a combination key and a coded key adapted to actuate said detent mechanism.

18. The locking system as recited in claim 17, further including at least one hole adapted to accept said at least one of a combination key and a coded key.

19. The locking system as recited in claim 1, wherein said locking block includes a plurality of holes adapted to accept a cord for securing additional items to the motorcycle.

20. A locking system for removably mounting and securing a saddlebag to a motorcycle, the area of the saddlebag disposed adjacent the motorcycle being made with a hard backing, said system comprising:
a locking block connected to the motorcycle;
a removable lock adapted to be disposed through the saddlebag and into said locking block to secure the saddlebag to the motorcycle;
at least one detent mechanism adapted to substantially prevent axial movement of said lock to secure the saddlebag and permit axial movement of said lock to release the saddlebag;
at least one of a combination key and a coded key adapted to actuate said detent mechanism; and
at least one hole adapted to accept said at least one of a combination key and a coded key.
